(19) United States
(12) Patent Application Publication
(10) Pub. No.: US 2005/0203909 A1
(43) Pub. Date: Sep. 15, 2005

(54) Device for searching for information from networked users and related methods

(76) Inventor: Yongjun Zhao, San Pedro, CA (US)

Correspondence Address: TONG & ASSOCIATES, Suite 400, 5850 Canoga Avenue, Woodland Hills, CA, 91367, US

(21) Appl. No.: 10/799,392

(22) Filed: Mar. 12, 2004

(51) Int. Cl. G06F 7/00

(52) U.S. Cl. 707/10

(57) ABSTRACT

The present invention includes a device comprising a plurality of interconnected computers. Each of the plurality of interconnected computers preferably includes a storage device that is configured to store a cookie entry when the computer user visits a web page. The cookie entry preferably comprises a path name, a description of web page content, and a uniform resource locator of the web page. The device further includes at least one processor in communication with the plurality of interconnected computers. The processor is preferably configured to accept a search query from a computer user, compare the search query with the cookie entry, and provide the computer user with the uniform resource locator of the cookie entry that match the search query.

### CROSS REFERENCE TO RELATED APPLICATIONS

None

### FIELD OF THE INVENTION

The present invention relates to computers having programs configured to provide service to other computers and, in particular, computers having programs that process search queries and allow networked users to share prior research information among each other.

### BACKGROUND

The World Wide Web offers vast information to people all over the world. Many surf the internet to shop, find services, or find useful information about a topic or issue. Typically, an internet search is conducted by visiting a popular search engine site, such as Google, MSN, or Yahoo. The searcher usually enters a keyword and instructs the search engine program to search the internet for websites that include the keyword. The search engine then produces a list of websites that include the keyword. In some cases, advertisements may appear on a portion of the searcher's screen. The advertisements may be banner advertisements or pop-up advertisements. The searcher may select an advertisement or a hyperlink from the list of relevant websites, and the search engine site directs the searcher to the site that is linked to the advertisement or listing.

From a searcher's perspective, one problem with the searching method described above is that a search query may obtain hundreds or thousands of results. The results may be overwhelming to the searcher. The searcher may only consider the first page of website listing and ignore the other results. Thus, the searcher is susceptible to missing the websites that may contain the needed information. It is desirable to have a system that utilizes a database of pre-selected information and that is highly organized to allow for effective on-line searches.

Another problem with existing search method from a searcher's perspective is that the visited websites may be difficult to store and retrieve. Some web browsing programs allow searchers to store websites in their list of favorite websites or to “bookmark” websites. However, when a user uses a different web browsing program, the user cannot access the list of favorite sites. Additionally, even if the user uses only one web browsing program, which allows the user to store websites, when the user tries to access the stored website, the web pages of the website may have transferred or may have expired, and thus rendering the stored information useless. It is desirable to have a program that stores website information and updates the stored information with changes to the web pages of the website.

Next, with existing web browsing programs, storing a website is not automatic. The user typically has to instruct the program to include the website in the list of favorites and provide a name for the website. Some users hesitate to add too many websites in their list of favorites, as the list may get too voluminous, and the websites may become difficult to locate. It is desirable to have a program that stores website information automatically and in a manner wherein the stored website information can be readily accessed with little or no restriction.

Another way visited websites are stored is through a history log, which may be provided by some web browsing programs. Again, when a user uses a different web browsing program, the user cannot access this history log. Additionally, the history log can easily be deleted. The history log is also poorly indexed, as it is based mainly on chronology. Often, searchers find it difficult to remember the dates when they visited a particular website. It is desirable to have a program that stores website information in a manner that is highly organized and easily searchable.

From the web site owners' perspective, one problem with the conventional searching method is that it is so competitive to be recognized on-line. It is common for web sites to have low click rates or low traffic of web visitors. Web site owners are forced to spend a substantial amount of money to have their websites search engine optimized to be in the top listing for a particular keyword. Banner ads and pop-up ads may not be viable alternative to search engine optimization (SEO), as they may be as expensive as the cost of an SEO. Additionally, some users tend to ignore banner and pop-up ads.

Business owners believe that word of mouth advertising may often be more effective than paid advertising. First, word of mouth advertising may not have any associated costs. Second, people who respond to word of mouth advertising are usually the ones who will buy the product or the service, as they are driven by the goodwill and good reputation of either the product or the service. Business owners typically have networking groups where they generate word of mouth advertising. It is desirable to adapt the current on-line searching technology to accommodate networking groups and word of mouth advertising.

On-Line Shopping

Shopping via the internet is usually conducted using the search method described above. Alternatively, an internet user may directly shop from a website of a product manufacturer that has a popular brand name. At least one problem with traditional on-line shopping method is that the on-line shopper does not have the opportunity to try the product before making a purchase. The on-line shopper usually has to buy the product first, wait for the product to arrive, and test the product. If the on-line shopper is dissatisfied with the product, the shopper has to repackage the product, drive to a local post office, and mail the product for a refund or exchange, which may take some time to arrive. Thus, when the on-line shopper buys a product on-line, the shopper has to take a lot of risk that so much time and hassle may be spent in returning the product. The on-line shopper also has to risk paying the shipping cost. Trial and error is very costly with internet shopping. Thus, a way to reduce the risks in the trial and error involved in on-line shopping is desired.

### SUMMARY

Brief Description

The present invention includes a method of conducting an on-line search. The method comprises allowing a first user to visit at least one web page; creating a cookie entry for the web page visited, the cookie entry comprising a description of web page content and a uniform resource locator of the web page; storing the cookie entry to the storage device of the first user; allowing a second user to enter a search query; comparing the search query with the cookie entry stored in the storage device of the first user; and, forwarding the uniform resource locator of the cookie entry to the second user if the search query matches the description of the web page content.

The above description sets forth, rather broadly, a summary of the preferred embodiments of the present invention so that the detailed description that follows may be better understood and contributions of the present invention to the art may be better appreciated. Some of the embodiments of the present invention may not include all of the features or characteristics listed in the above summary. There are, of course, additional features of the invention that will be described below and will form the subject matter of claims. In this respect, before explaining at least one preferred embodiment of the invention in detail, it is to be understood that the invention is not limited in its application to the details of the construction and to the arrangement of the components set forth in the following description or as illustrated in the drawings. The invention is capable of other embodiments and of being practiced and carried out in various ways. Also, it is to be understood that the phraseology and terminology employed herein are for the purpose of description and should not be regarded as limiting.

### BRIEF DESCRIPTION OF THE DRAWINGS

FIG. 1 is substantially a schematic view of one embodiment of the referral device of the present invention.

FIG. 2 is substantially a flow chart of a query processing protocol configured to be executed by the referral device of FIG. 1.

FIG. 3 is substantially a flow chart of a cookie storage program configured to be executed by the referral device of FIG. 1.

FIG. 4 is substantially a flow chart showing how a key is created for a uniform resource locator.

FIG. 5 is substantially a flow chart of an acceptance protocol configured to be executed by the referral device of FIG. 1.

FIG. 6 is substantially a flow chart of a search protocol configured to be executed by the referral device of FIG. 1.

FIG. 7 is substantially a schematic view of the referral device of the present invention shown to be accepting a search query, processing the search query, and providing search results to the searcher.

FIG. 8 is substantially a schematic view of another embodiment of the referral device of the present invention that includes a server and a mapping service provider.

FIG. 9 is substantially a schematic view of another embodiment of the referral device of the present invention that includes a server and a mapping service provider.

### DETAILED DESCRIPTION

In the following detailed description of the preferred embodiments, reference is made to the accompanying drawings, which form a part of this application. The drawings show, by way of illustration, specific embodiments in which the invention may be practiced. It is to be understood that other embodiments may be utilized and structural changes may be made without departing from the scope of the present invention.

As used herein, the term “network” may include the “internet” and thus the term “network” is interchangeably used with the term “internet.” Both terms are used to refer to a communication system that allows users to connect and transmit data between computers, terminals, or databases. The term “internet” may also include and may interchangeably be used with the term “world wide web.” The term “websites” may be used to refer to a group of web pages. The term “web page” may be used to refer to a block of data available on the world wide web. The term “websites” may be used interchangeably with the term “web pages.”

The term “computer” may include a “server” and thus the term “computer” is interchangeably used with the term “server.” Both terms are used to refer to an electronic device or a plurality of connected electronic devices that can store, retrieve, or process data or that can provide service for computers connected thereto.

The term “computer” for example may be a personal computer, which may further be a laptop computer or a desktop computer. The term “computer” may further be a personal digital assistant (PDA) or a mobile phone. The terms “server” or “computer” are not limited by their physical location. A server or computer may be a home computer, an office computer, or a remotely accessible computer.

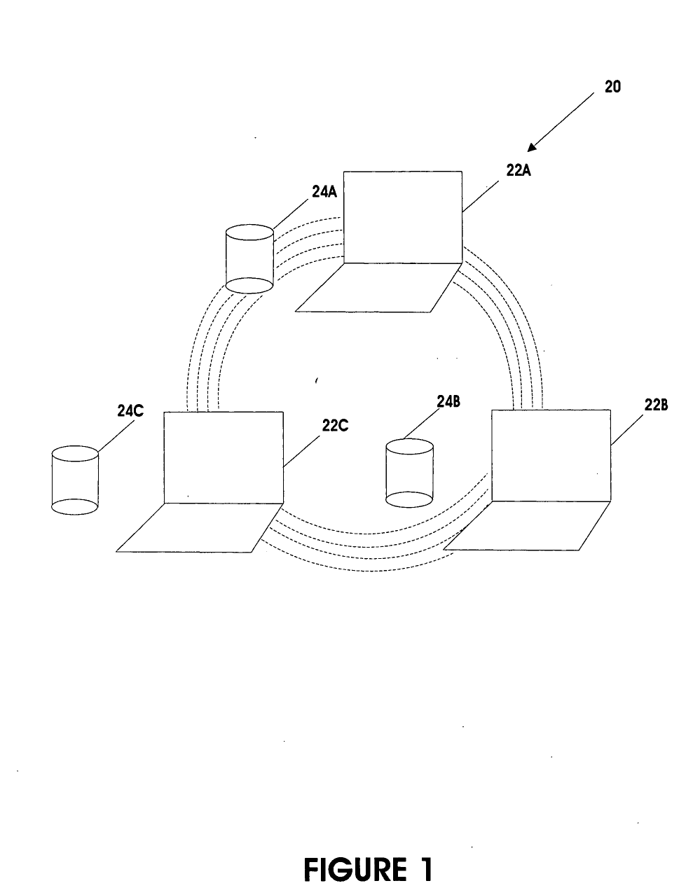

The present invention comprises a referral device (RD) 20 and related methods. RD 20 preferably promotes referral of data between subscribers. The data being referred among the subscribers may be in a form of information about a product, a service provider, or websites that contain useful information about a topic. With reference to FIG. 1, RD 20 preferably includes a plurality of networked computers 22a, 22b, and 22c. The computers 22a-c may be networked via a peer-to-peer network, a server, internet, or other methods known in the art. Each computer preferably includes its own storage device 24a-c that is configured to store a user's cookie. As used herein, the term “cookie” is used to refer to a file containing a user's information, such as a user identification code, customized preference, internet search queries, or a record of web pages visited. The storage devices 24a-c may be an internal memory, such as a computer's hard drive, external memory, random access memory, read only memory, and any device that can hold data in a machine-readable format.

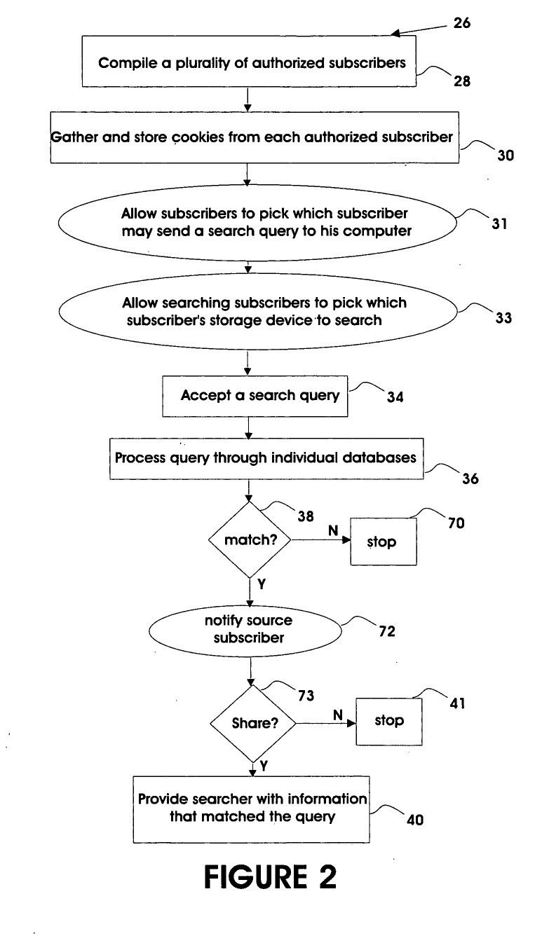

The flowchart shown in FIG. 2 will now be discussed in details. It is noted that, as with any flowcharts presented and discussed herein, the order in which the steps are presented does not necessarily imply that they have to be performed in the order presented. It will be understood by those of ordinary skill in the art that the order of these steps can be rearranged and performed in any suitable manner. It will further be understood by those of ordinary skill in the art that some steps may be omitted or added and still fall within the scope of the invention.

With reference now to FIG. 2, RD 20 preferably includes a program configured to execute a query processing protocol 26. The query processing protocol 26 preferably compiles a plurality of authorized subscribers 28. The protocol 26 preferably gathers and stores the cookies from each authorized subscriber at step 30. For instance, when an authorized subscriber searches the World Wide Web, the protocol 26 preferably records and stores the web pages visited by the subscriber. The cookies are preferably stored in the subscriber's own local storage device.

At step 31, RD 20 preferably allows subscribers to indicate which subscriber may send a search query to his computer. At step 33, RD 20 preferably allows a searching subscriber (hereinafter referred to as the “searcher”) to indicate which subscriber's storage device to search. The storage device of the subscriber, who indicates that he does not want the searcher to send a search query to his computer, is preferably not displayed to the searching subscriber. Thus, the storage device is not offered as one of the storage device the searching subscriber may search.

At step 34, the protocol 26 preferably accepts a search query from an authorized subscriber. The search query is then processed by finding a match between the search query and the cookies stored in the individual storage devices of the authorized subscribers (steps 36 and 38). If no match is found, RD 20 is preferably configured to stop (step 70).

If a match is found, RD 20 preferably notifies the subscriber whose storage device contained the matching information (hereinafter referred to as the “source subscriber”) about the searcher's identity, the search query, and the matching information found in his storage device. RD 20 preferably prompts the source subscriber whether to share the matching information at step 73. If the source subscriber indicates he does not want to share the matching information, RD 20 is preferably configured to stop (step 41). If the source subscriber indicates he wants to share the matching information, RD 20 preferably provides the searcher with information, such as a universal resource locator (URL), at step 40. The source subscriber may be allowed to edit the information destined to be sent to the searcher.

It is noted that RD 20 is preferably configured not to send a notification to the searcher that no matching information is found or that the source subscriber did not authorize the release of the matching information. By configuring RD 20 not to send a notification to the searcher that the source subscriber did not authorize the release of the matching information, a congenial atmosphere between subscribers is maintained. Additionally, by configuring RD 20 not to send a notification to the searcher that no matching information is found, no additional time is taken to process the notification. If additional time is taken to process the notification, the searcher may think that matching information was probably found, and that the source subscriber is taking some time to decide whether to release the information. Thus, any notification regarding a lack of matching information is preferably eliminated. In other embodiments, the searcher may be allowed to request to be notified regarding a lack of matching information.

RD 20 and the query processing protocol 26 may be used as a consumer selection tool that helps consumers effectively screen advertisements. For example, RD 20 may serve a group of friends as authorized subscribers. The group of friends may use the RD 20 as a way to recommend products to each other. When an authorized subscriber is shopping for a product, the authorized subscriber may enter a description of the product as a search query on RD 20. The protocol 26 preferably scans through the individual databases of the authorized subscribers to see if any of them have bought, inquired, or known the product described. If the protocol 26 finds a match, then the searching subscriber is preferably provided with a list of web pages found in at least one authorized subscriber database to match the search query. Accordingly, the searching subscriber may narrow his or her search of the product, for example, by visiting only the web pages previously visited by a fellow authorized subscriber.

RD 20 and the query processing protocol 26 may also be used as a data sharing tool. For example, RD 20 may serve a group of professionals in an industry, such as a group of lawyers working for a single law firm (referred to as “authorized subscribers” for this example). When an authorized subscriber is searching for recent news about a new legislation, the authorized subscriber may enter a description of the issue covered by the new legislation as a search query. The protocol 26 preferably scans through the individual databases of the authorized subscribers to see if any of them have read, inquired, or known about the issue presented. If the protocol 26 finds a match, then the protocol 26 may provide to the searcher the web pages visited by fellow authorized subscribers, so that the searcher may easily find the information he or she needs. It can be appreciated that RD 20 may be useful for other applications where a computer user can take advantage of data collected from previous research of other computer users.

Gathering and Storing of Cookies

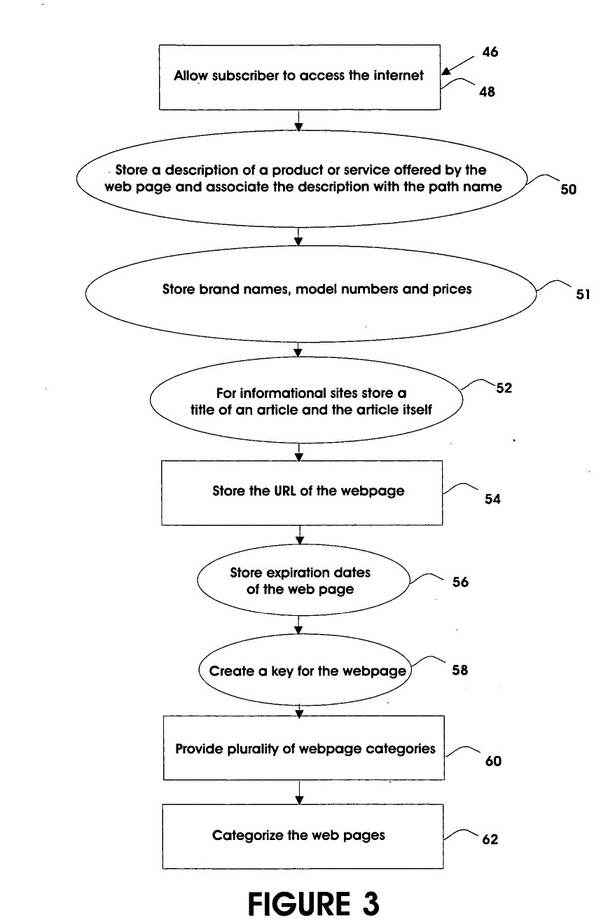

Web pages are commonly created with embedded language, such as java script, or other script languages known in the art, such as ASP and JSP. Cookie storage program 46 (FIG. 3) preferably causes a website or a server site that hosts a website to set a cookie entry in the local database of a user. In the preferred embodiment, the cookie entries are stored as the subscriber clicks on a hyperlink or a banner ad that takes the subscriber to a website. In alternative embodiments, the cookie entries are stored after the subscriber clicks on the hyperlink or banner and when the web browser is loading the web page linked to the hyperlink or banner.

Each cookie entry preferably includes a path. The path preferably includes an indicia recognizable by the processor as a cookie for RD 20 and a search category. Thus, a sample cookie entry may be /3Treesnetwork/computer/laptop./3Treesnetwork/ is the indicia. Computer/laptop is the search category. The path preferably allows a search engine to recognize the entry and consider the entry when processing a search query using RD 20. Thus, if the searcher initiates a search through RD 20 and indicates “laptop” as the category, a processor may consider entries having the path /3Treesnetwork/computer/laptop.

Each cookie entry also preferably includes a name-value pair. The name-value pair preferably includes a description of a product, service, or information and the URL where the product information may be obtained. An example of a name-value pair may be a “brandx laptop advanced series 1100 $890”=“http://www.brandx.com/abc.htm.” The search engine may compare the search query with the description to find a match. For instance, the subscriber may conduct a keyword search on RD 20 using the keywords “Brandx” and “laptop.” The local search engine will search from the values in the name-value pairs having the keywords “Brandx” and “laptop.”

Each cookie entry also preferably includes an expiration date. The expiration date may be a specific date wherein the URL may no longer be active. If the URL is designed not to be inactive at any time, an expiration date that indicates perpetual activation may be provided. The expiration date may be especially helpful when there is a promotion that is offered for a limited time. The expiration date may allow the search engine to consider the generic description only if the search query was processed before the expiration date. One advantage of the expiration date is that the searcher is saved from outdated or invalid promotions.

In another embodiment, each cookie entry preferably includes a path, a key-name pair, and an expiration date. The key-name pair preferably includes a key to solve a URL and a description of a product, service, or information. An example of a key-value pair may be “keyABC”=“brandx laptop advanced series 1100”. One advantage of using a URL key is that the key can accommodate web site changes. For instance, if a website was updated and the URL is changed, the mapping between the URL and the key may be updated. Another advantage is that the number of times the URL associated with the key is visited can be monitored.

It can be appreciated that by including a key-name pair in a cookie entry, web masters cannot simply associate their web page with a frivolous service or product description. For instance, web masters for a Company A belonging to an Industry A cannot simply include a web page mentioning a product belonging to Industry B so that Company A's website can be referred to other people entering a search query for products belonging to Industry B. With a key-name pair feature, the mapping system may require a matching key and description before it can release any information to the searcher.

With reference now to FIG. 3, RD 20 preferably executes a cookie storage program, such as the cookie storage program 46. Beginning at step 48, RD 20 preferably allows an authorized subscriber to access at least one web page on the internet. At step 50, RD 20 is preferably configured to store in a local database a description of a product or service offered by the web pages and associate the description with the path name. At step 51, RD 20 is preferably configured to store the corresponding proper names, such as brand names, model numbers, and prices, as values. If the web page does not offer any products or services, and the web page only offers information, RD 20 preferably stores in a local database a general description of the type of information the web page presents (step 52). For instance, RD 20 may store a title of an article and the contents of the article.

Next, RD 20 preferably stores the URL of the website (step 54). RD 20 may store any expiration dates of the web page (step 56). In the preferred embodiment, RD 20 may create keys for the URLs (step 58). RD 20 preferably defines a plurality of web page categories (step 60), and categorizes the stored web page information according to the plurality of categories (step 62). For example, one category may be “computers” and a subcategory may be “laptops” and “desktops.” Every time a subscriber visits a site that mentions or sells computers, the site will be stored under the “computer” directory. It is noted that RD 20 preferably stores cookies in a local database or in a storage device of a subscriber's computer to control the privacy of the cookies. Through this manner of storing the cookies, each subscriber may have the ability to control who can access his storage device. RD 20 preferably includes another privacy feature, which is the ability to allow subscribers to check and modify the cookie contents of their local storage device.

Creation of URL Keys

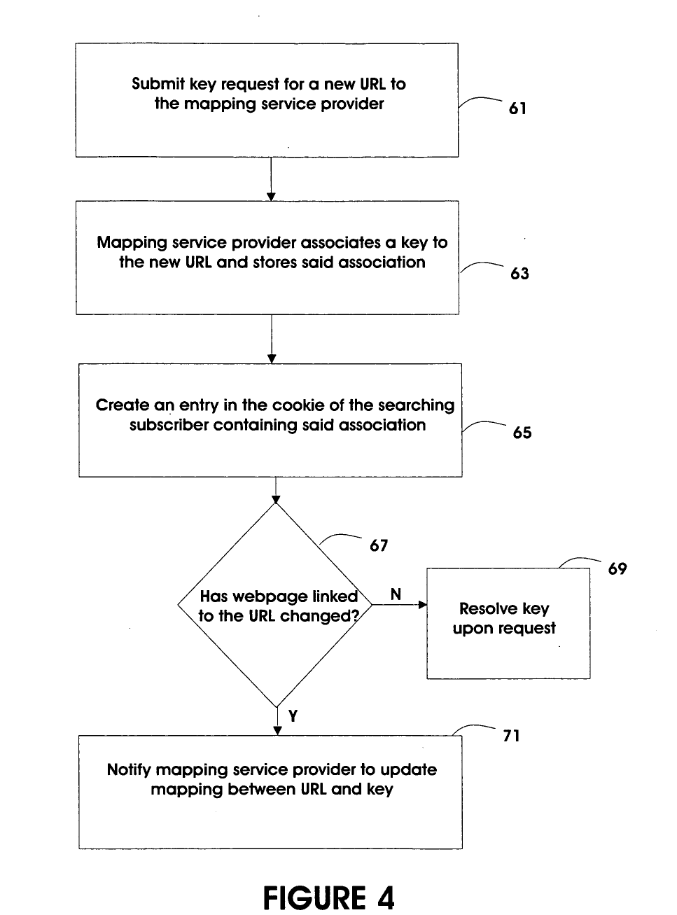

With reference now to FIG. 4, a flow chart detailing how an embodiment of RD 20 may map URLs with URL keys is shown. At step 61, for each new URL, a key request for the new URL is preferably submitted to a mapping service provider. The mapping service provider may be a computer or a server that is configured to process requests to create a new key or requests to resolve the key of a particular URL. Next, at step 63, the mapping service provider preferably associates a key with the URL submitted and stores said association in the mapping service provider database.

At step 65, when a subscriber clicks on the URL, an entry in the cookie of the searching subscriber regarding the association between the key and the URL is preferably created. The cookie may be created by the programmer of the website that is linked to the URL. At step 67, any changes to the web pages linked to the stored URLs are preferably monitored. If there are no changes, the mapping service provider is configured to resolve the key associated with the URL when requested (step 69). If there are changes to the webpage linked to the URL, which is being requested to be resolved by the mapping service provider, RD 20 is preferably configured to notify the mapping service provider to update the mapping between the URL and the key.

Accepting Search Queries

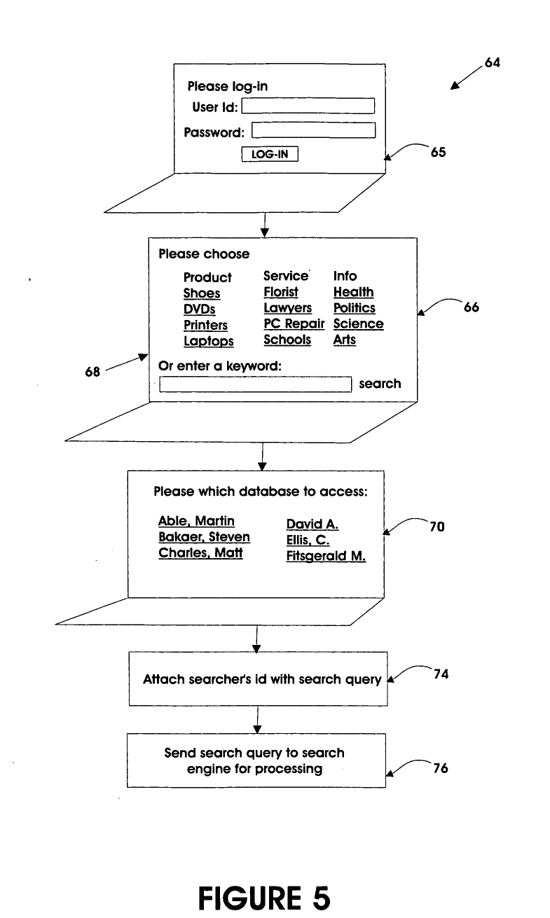

With reference now to FIG. 5, RD 20 preferably accepts search queries from authorized subscribers using acceptance protocol 64. Beginning at step 65, the authorization of the searching subscriber is preferably verified. If the searching subscriber has proper authorization, at step 66, RD 20 preferably provides a searching subscriber (not shown) with a categorized list of products or services. The list is preferably displayed on the searching subscriber's monitor. The subscriber may select from the list of products and services. Alternatively, the searching subscriber may enter keywords for the search (step 68).

Next, RD 20 preferably displays a list of databases of authorized subscribers to the searching subscriber (step 70) so that the searching subscriber may select the database of cookies the searching subscriber wants to access. After the searching subscriber selects the databases, RD 20 preferably attaches the searching subscriber's identity with the search query (step 74) and sends the search query to a search engine for processing (step 76). It is noted that RD 20 may be configured to store the search query for offline authorized subscribers and schedule the search query to be sent to the authorized subscribers when they are on-line.

RD 20 preferably includes a communication infrastructure and a search engine that use Real Time Messenger Technology (RTMT). The list of databases of authorized subscribers may be maintained with the RTMT. RTMT may allow users to pick which authorized subscriber may access their databases. RTMT may allow users to pick which authorized subscriber database to access. The search query may be forwarded to the search engine using RTMT. The result of the search query may be forwarded to the searcher using RTMT.

Processing the Search Query

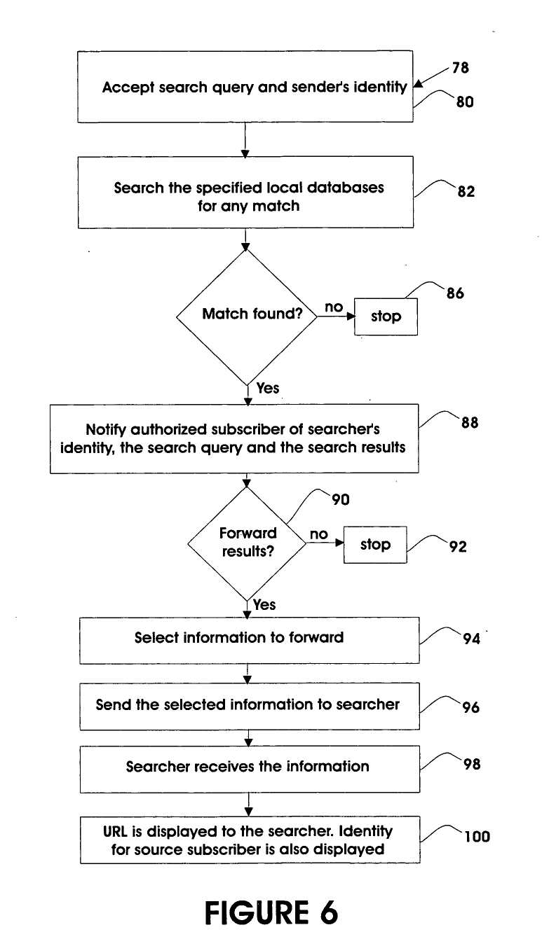

Once the search engine (not shown) receives the search query, the search engine preferably executes the search protocol 78 shown in FIG. 6. Beginning at step 80, the search engine preferably resolves the search query into the keyword entered or description of the product, service, or information and sender's identity. At step 82, the search engine preferably searches the selected databases for any match between the keyword entered or description of the product, service, or information and the stored cookies. If there is no match, the search engine preferably stops (step 86).

At step 88, if there is a match found, the search engine preferably notifies the authorized subscriber whose database was accessed and whose database contained the matching information (hereinafter referred to as the “source subscriber”). The notification preferably includes the sender's identity, the search query, and the search result. It is noted that RD 20 preferably includes a search protocol that provides the source subscriber the option to control the release of the information taken from his database. Thus, at step 90, the search engine preferably waits for an instruction from the source subscriber to forward the information to the searcher.

If the source subscriber does not want to forward the information, the search engine preferably drops the notification and stops (step 92). If the source subscriber decides to forward the information, the search engine preferably allows the source subscriber to select the information to forward (step 94). Once the source subscriber selects the information, the search engine forwards the selected information to the searcher (step 96). If the searcher is offline, the search engine is preferably configured to store the information and is preferably programmed to forward the information to the searcher when the searcher is on-line. The searcher then receives the information (step 98), and the search engine preferably displays URLs associated with the information received and the identity of the subscriber from whom the information was obtained (step 100).

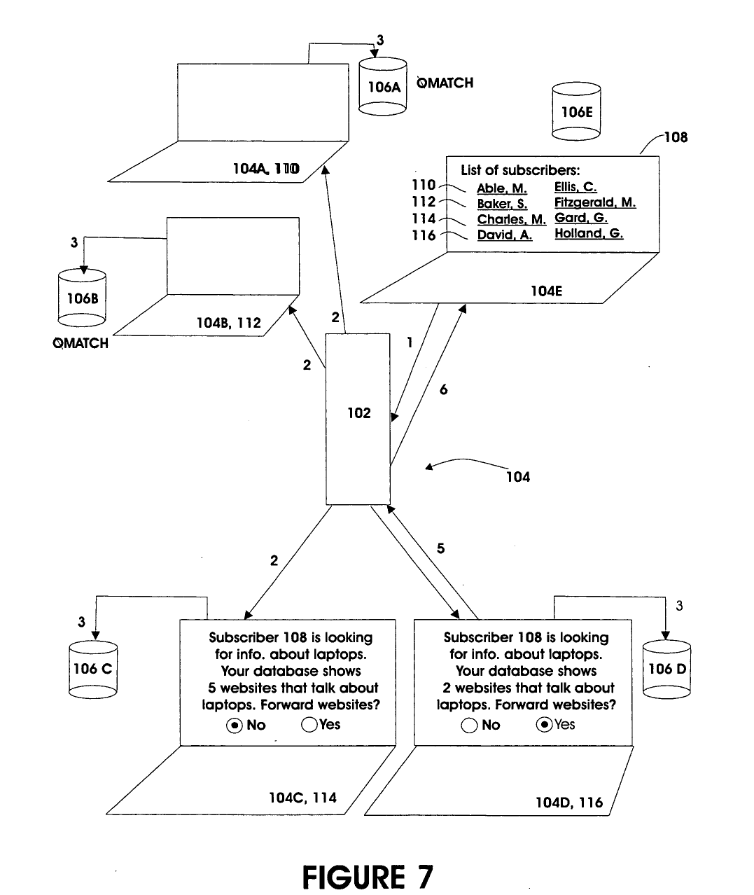

An embodiment of RD 20 that uses a server 102 as part of the computer network 104 is shown in FIG. 7. It is noted that RD 20 may be implemented on a peer-to-peer network without any server. With continued reference now to FIG. 7, a plurality of computers 104 a, b, c, d, and e are in communication with each other through the server 102. Computers 104a-e preferably have their respective database or storage device 106a-e. In the example shown in FIG. 7, the monitor of the searching subscriber or the searcher 108 may display a list of subscribers whose database may be a source of data.

The searcher 108 may select any one or all of the subscribers 110, 112, 114, and 116. Once the searcher 108 has made a selection, the searcher may enter a search query on his computer 104e and send the query to the server (as shown by “1”). The server 102 may distribute the search query to the selected subscribers, for example, subscribers 110, 112, 114, and 116 (as shown by “2”). The search engine from the selected subscriber's computers preferably scans the search query through its respective database to find information that matches the search query (as shown by “3”).

In the example shown in FIG. 7, the databases of subscribers 110 and 112 did not find a match between the search query and the information in the databases. The databases of subscribers 114 and 116 found a match between the search query and their stored information. Subscribers 114 and 116 are notified of the searcher's identity, the search query, and the search results (as shown by “4”). Subscribers 114 and 116 are preferably allowed to decide whether to forward the matching information found from their databases to provide privacy control to them. The search results may include a listing of the web pages visited, hyperlinks thereto, and a checkbox or a place for the source subscriber to indicate whether or not to forward a particular web page.

It is noted that RD 20 preferably conducts the search in the background. That is, the subscribers whose databases were searched are the only ones notified, and they are preferably notified only if the information from their databases are about to be released to the searching subscriber. With this technique, any unnecessary notifications to the subscribers are substantially eliminated. In alternative embodiments, the subscribers may be allowed to specify the kind of notification they receive. For instance, they may choose to receive a notification that RD 20 is about to search their storage devices, that information from their storage devices are about to be shared to an identified subscriber, or all of the above notifications. Thus, subscribers may initially be asked specify the type of notifications they want to receive so they may have the option to terminate any processes being conducted on their computers.

In the current example, subscriber 114 decides not to forward the matching information from his database to the searcher. It is noted that RD 20 preferably does not notify the searcher of a source subscriber's decision not to share matching information found from his database to maintain a congenial atmosphere between the authorized subscribers. The source subscriber preferably appears before the searcher just like any other subscriber whose database did not contain any information that matches the search query. With this technique, the chances of subscribers having negative feelings against one another due to a subscriber's decision not to share information are substantially eliminated.

Subscriber 116 decides to forward the matching information found in his database to the searcher. Subscriber 116 may provide a comment about particular information. For instance, if subscriber 116 remembers something very distinctive about a product, such as the product's performance, subscriber 116 may include a comment, such as “this is the best laptop I have ever owned.”

Computer 106d preferably communicates the information and any additional comment to the server 102 (as shown by “5”). The server 102 preferably forwards the information to the searcher's computer 104e (as shown by “6”). For instance, the server may cause the searcher's monitor to indicate “Subscriber 116 replies to your query for a laptop. Laptops: Brandx Advanced Series 1100 $899.” A hyperlink to the website may be provided. The results may be delivered in real time. Alternatively, the results may be stored and forwarded once the searcher is on-line. The results may be time-stamped to notify the searcher when RD 20 furnished the results.

Resolving URL Keys

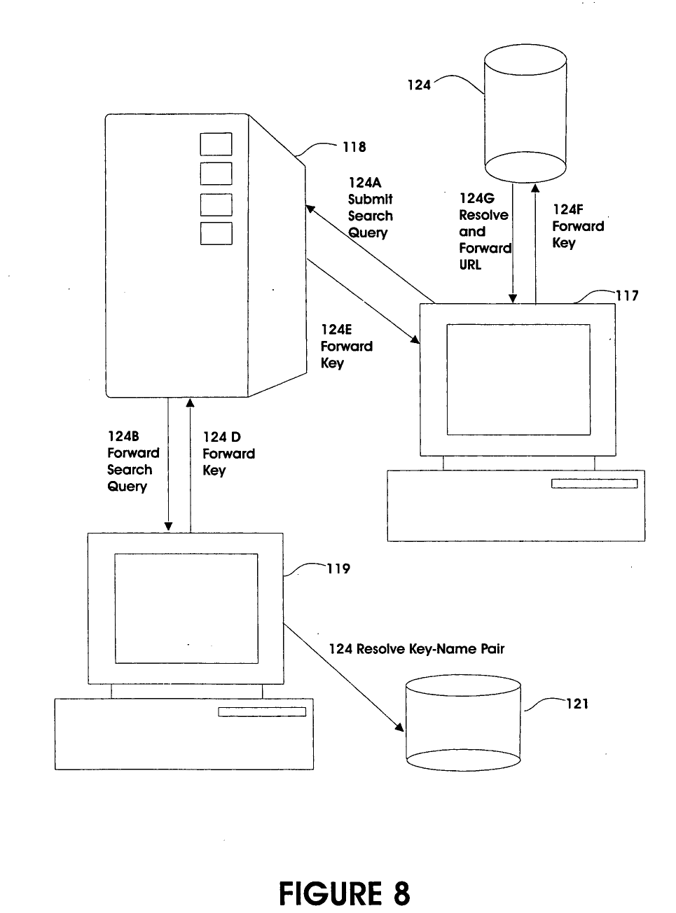

With reference now to FIG. 8, an embodiment of RD20 that stores cookies with URL keys preferably processes search queries as follows. It is noted that the steps below may be combined with the steps in FIG. 7. A searcher preferably enters a search query using his computer 117. The search query is submitted to a server 118 at step 124A. The server 118 forwards the search query to another subscriber's computer 119, which may potentially contain the information the searcher needs.

The subscriber's computer 119 scans through its cookie database 121 to find a match between any information stored and the search query. If a match is found, computer 119 preferably resolves the key name pair at step 124 C. At step 124D, computer 119 preferably forwards the key to server 118. The server 118 preferably forwards the key to the searcher's computer 117 at step 124E. The searcher's computer 117 preferably forwards the key to a database containing mapping information between keys and URLs 124 where the associated URL is extracted from the key. At step 124G, the URL is forwarded to the searcher's computer.

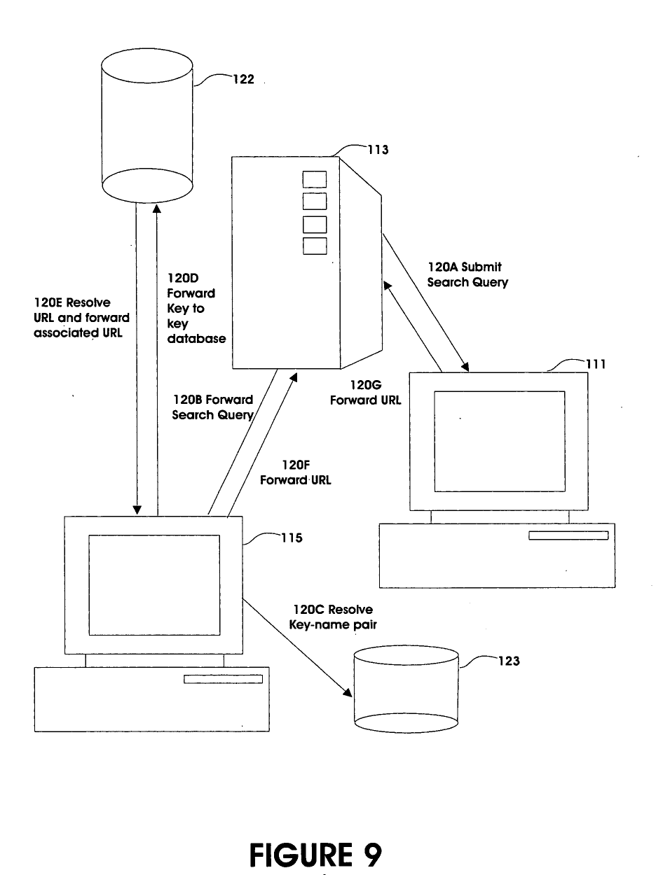

With reference to FIG. 9, another embodiment of RD20 that stores cookies with URL keys preferably processes search queries as follows. It is noted that the steps below may be combined with the steps in FIG. 7. A searcher preferably enters a search query using his computer 111. The search query is submitted to a server 113 at step 120A. The server 113 forwards the search query to another subscriber's computer 115, which may potentially contain the information the searcher needs.

The subscriber's computer 115 scans through its cookie database 123 to find a match between any information stored and the search query. If a match is found, computer 115 preferably resolves the key name pair at step 120 C. At step 120D, computer 115 preferably forwards the key to a database containing mapping information between keys and URLs 122 where the associated URL is extracted from the key. If the URL is not found, RSD 20 may notify the searcher and the source subscriber. One possible cause for missing URL is that the entry in the cookie may be a spam or ill intended, or that the associated website stored spam information in the cookie. It can be appreciated that certain embodiments of the present invention prevent websites from storing spam or ill intended information in the cookie. Ill intended information may include the frivolous cookie entry described above. If the URL is found, at step 120E, the URL is forwarded to the searcher's computer 115, to the server 113 (step 120F), and subsequently to the searcher's computer 111 (step 120G).

It is noted that the embodiments of RD 20 shown in FIGS. 8 and 9 include a feature that provides privacy to the users. To illustrate, as shown in FIG. 9, the server 113 is not in direct communication with the mapping database 122. Accordingly, where the server 113 is an internet service provider (ISP), the ISP does not have the ability to see the web pages users have visited and recorded in mapping database 122 without the users consent.

It can now be appreciated that certain embodiments of the present invention enable computer users to share research data. The research data may be data pertaining to product comparisons or service provider comparisons. Thus, certain embodiments of the present invention allow users to conveniently refer a particular product or a particular service provider to another. Users benefit by saving time from having to scan through numerous web pages and advertisements. Users further benefit by being able to obtain first-hand information about a product before ordering the product on-line. Thus, the risk in the trial and error associated with current on-line shopping technology is minimized. Web site owners also benefit by being able to adapt word of mouth advertising to e-commerce technology.

In the preferred embodiment, the manner in which users solicit information from others is discreet. The subscribers whose database may contain the desired information is preferably not notified of the search unless information coming from his database is about to be released. Certain embodiments of the present invention provide privacy for subscribers. Subscribers may be provided with information about the searcher, the search query, and the results of the search query preferably before information from a subscriber's database is shared.

It can further be appreciated that certain embodiments of the present invention allow users to store web site information in a manner that is highly organized and current. Certain embodiments of the present invention automatically store information about the web pages visited by the user. Certain embodiments store the web pages by pre-defined categories. Furthermore, certain embodiments store the web pages and update the web pages with any changes in the URL or the content.

Although the description above contains many specifications, these should not be construed as limiting the scope of the invention but as merely providing illustrations of some of presently preferred embodiments of this invention. For example, the individual steps in implementing certain aspects of the invention do not have to be conducted in any one particular computer. The steps can be conducted on a personal computer, a public shared computer, a server, or on the combination of any of these computers. Certain log in procedures discussed above may also be eliminated. Each cookie entry may further be stored in different formats. Thus, the scope of the invention should be determined by the appended claims and their legal equivalents rather than by the examples given.

1) A method of sharing information on-line, the method comprising:
A) connecting a plurality of computers as a network, the plurality of computers being configured to be used by computer users;
B) providing individual storage devices to each of the plurality of computers;
C) allowing the computer users to visit web pages;
D) creating cookie entries when the users visit web pages, each cookie entry comprising a description of contents of web pages;
E) storing the cookie entries of each computer user into their respective storage devices;
F) allowing at least one computer user to enter a search query; and
G) comparing the search query with the cookie entries stored in the individual storage devices, thereby providing the user who entered the search query an option the limit the search within the web pages visited by the plurality of computer users.

2) The method of claim 1, wherein each cookie entry comprises a uniform resource locator of the web page visited.

3) The method of claim 2, further comprising providing the user, who entered the search query, with the uniform resource locator of the cookie entry that matched the search query.

4) The method of claim 2, further comprising storing the uniform resource locator of the cookie entry that matched the search query and releasing said uniform resource locator to the user who entered the search query when the user is connected to the network.

5) The method of claim 1, further comprising alerting the computer user whose storage device contains a cookie entry that matches the search query.

6) The method of claim 2, further comprising allowing the computer user, whose storage device contains a cookie entry that matches the search query, to deny the release of the uniform resource locator.

7) The method of claim 6, further comprising disguising the computer user, whose storage device contains a cookie entry that matches the search query and who denied the release of the uniform resource locator, as a computer user without said cookie entry.

8) The method of claim 1, further comprising allowing the computer users to specify which computer user may run a search query through their individual storage devices.

9) The method of claim 1, further comprising allowing the computer users to specify which individual storage devices they want to have access.

10) The method of claim 2, further comprising creating a key and associating said key to a uniform resource locator.

11) The method of claim 10, wherein each cookie entry further comprises an expiration date, the expiration date being configured to cause a change in the uniform resource locator of the cookie entry, the method further comprising updating the association of the key and the uniform resource locator after the expiration date.

12) A device comprising:
A) a plurality of interconnected computers, each of the plurality of interconnected computers being configured to be used by a computer user, each of the plurality of interconnected computers comprising a storage device, each storage device being configured to store a cookie entry when the computer user using the respective computer visits a web page, the cookie entry comprising a description of web page content and a uniform resource locator of the web page; and
B) at least one processor in communication with the plurality of interconnected computers, the processor being configured to accept a search query from a computer user, compare the search query with the cookie entry, and provide the computer user with the uniform resource locator of the cookie entry that match the search query.

13) The device of claim 12, further comprising a mapping service provider connected to the plurality of interconnected computers, the mapping service provider being configured to create a key for a uniform resource locator of a webpage, associate the key to the uniform resource locator, and store said association.

14) The device of claim 13, wherein the processor is configured to cause the mapping service provider to update the stored association between the uniform resource locator and the key with at least one change in the uniform resource locator.

15) The device of claim 13, wherein the cookie entry, further comprises an expiration date, the occurrence of the expiration date being configured to cause a change in the uniform resource locator, the method further comprising allowing the mapping service provider to update the stored association between the uniform resource locator and the key with the change.

16) The device of claim 12, wherein the processor further comprises a real time messenger program, the real time messenger program being configured to prompt the user to enter a search query.

17) The device of claim 16, wherein the real time messenger program is configured to inform the computer user of the uniform resource locator of the cookie entry that match the search query.

18) The device of claim 16, wherein the real time messenger program is configured to allow users of the plurality of interconnected computers to pick which users may access their individual storage devices.

19) The device of claim 16, wherein the real time messenger program is configured to allow users of the plurality of interconnected computers to pick which individual storage devices they want to search.

20) The device of claim 16, wherein the real time messenger program is configured to notify the user whose individual storage device contained the cookie entry that matched the search query about the search, the real time messenger program being further configured to allow the user whose individual storage device contained the cookie entry that matched the search query to control the release of the uniform resource locator to the searching user.

21) The device of claim 20, wherein the real time messenger program is configured to allow the user whose individual storage device contained the cookie entry that matched the search query to edit information to be released to the searching user.

22) A method of conducting an on-line search, the method comprising:
A) allowing a first user to visit at least one web page;
B) creating a cookie entry for the web page visited, the cookie entry comprising a description of web page content and a uniform resource locator of the web page;
C) storing the cookie entry to the storage device of the first user;
D) allowing a second user to enter a search query;
E) comparing the search query with the cookie entry stored in the storage device of the first user; and
F) forwarding the uniform resource locator of the cookie entry to the second user if the search query matches the description of the web page content.

23) The method of claim 22, further comprising alerting the first user of the search query and the identity of the second user, if the search query matches the description of the web page content.

24) The method of claim 23, further comprising allowing the first user to prevent the forwarding of the uniform resource locator to the second user.

25) The method of claim 24, further comprising preventing the second user from knowing that the first user prevented the forwarding of the uniform resource locator.

26) The method of claim 22, further comprising associating a key with the uniform resource locator of the web page and forwarding the key instead of the uniform resource locator to the second user.

27) The method of claim 22, further comprising providing a key storage device for storing the association of the key and the uniform resource locator.

28) The method of claim 27, further comprising resolving the uniform resource locator from the key storage device and forwarding the uniform resource locator to the second user.

29) A device comprising:
A) a first computer, the first computer comprising a first storage device, the first computer being configured to be used by a first user, the first storage device being configured to store at least one cookie entry, the cookie entry comprising a description of the web page visited by the first user and a uniform resource locator corresponding to the web page;
B) a second computer connected to the first computer, the second computer comprising a second storage device, the second computer being configured to be used by the second user, the second storage device being configured to store at least one cookie entry, the cookie entry comprising a description of the web page visited by the second user and a uniform resource locator corresponding to the web page;
C) a mapping service computer in communication with the first computer, the mapping service computer being configured to associate an individual key to each uniform resource locators stored in the first and second storage devices, the mapping service computer being further configured to store the associations between the key and the uniform resource locator, wherein the first user may enter a search query and cause the second computer to accept the search query and compare the search query with the cookie entry stored in the second storage device, if the search query matches the stored description of the web page, the second computer being configured to provide the key to the first computer, the first computer being configured to cause the mapping service computer to resolve the uniform resource locator of the web page from the key and forward said key to the first computer.
